(19) United States
(12) Patent Application Publication
(10) Pub. No.: US 2013/0146166 A1
(43) Pub. Date: Jun. 13, 2013

(54) AUTO SHUTOFF DEVICE

(71) Applicants: Serge Campeau, Lancaster, NY (US); Douglas Charles Heiderman, Akron, NY (US); Ashwini Sinha, East Amherst, NY (US)

(72) Inventors: Serge Campeau, Lancaster, NY (US); Douglas Charles Heiderman, Akron, NY (US); Ashwini Sinha, East Amherst, NY (US)

(21) Appl. No.: 13/313,964

(22) Filed: Dec. 7, 2011

(51) Int. Cl. F16K 15/14

(52) U.S. Cl. 137/843

(57) ABSTRACT

This invention is directed to an auto shut off device which includes a restrictive flow orifice (RFO) disc designed to restrict and isolate gas flow. The RFO disc is designed to flex in response to a specific pressure drop that develops as a result of a system failure. When the failure occurs, the RFO disc flexes into a sealed position which blocks the discharge flow path. In this way, the RFO disc functions as an auto shut off device that confines the gas upstream of the disc.

### FIELD OF THE INVENTION

The present invention relates to an auto shut off device capable of restricting gas flow under normal operating conditions and shutting off gas flow in response to a downstream catastrophic failure.

### BACKGROUND OF THE INVENTION

Industrial processing and manufacturing applications, such as semiconductor manufacturing, typically require the safe handling of toxic, corrosive and/or flammable hydridic and halidic gases and mixtures thereof. By way of example, the semiconductor industry often relies on the gaseous hydrides of silane (SiH₄), and liquefied compressed gases such as arsine (AsH₃) and phosphine (PH₃) for wafer processing. Various semiconductor processes utilize SiH₄, AsH₃ or PH₃ from vessels that have storage pressures as high as 1500 psig. As a result of their extreme toxicity and high vapor pressure, uncontrolled release of these gases, due to delivery system component failure, or human error during cylinder change-out procedures, may lead to catastrophic results. For example, the release of a flammable gas such as silane may result in a fire, system damage and/or potential for personal injury. Leaks of a highly toxic gas, such as arsine, could result in personal injury or even death.

Silane is an example of how a toxic gas is typically used by the semiconductor industry. Silane is stored as a gas phase product in pressurized containers at about 1500 psig or higher. A leak in one 140 gram cylinder of silane could contaminate the entire volume of a 30,000 square foot building with 10 foot high ceilings to the Immediate Danger to Life and Health (IDLH) level. If the leak rate were sufficiently large, contamination to the IDLH level could occur within minutes, which would mean that there would be deadly concentration levels in the area near the source of the spill over a sustained time.

In light of the safety hazards associated with the unintended release of gases and liquefied compressed gases from high pressure cylinders, several mechanical systems have been designed and developed to improve upon their storage and delivery. However, the systems remain ineffective. For example, the release rate of the toxic gases, as a result of a failure from current cylinder storage and delivery cylinders, is controlled but still sufficiently high to cause contaminant concentration levels in a production environment to reach IDLH levels. The inability for current systems to adequately reduce the release rate fails to enhance the safe handling of hydridic and halidic gases in a semiconductor production environment.

Further, there may be instances in which flow restriction is not adequate to ensure safety of the environment surrounding the area of the cylinder. Complete flow isolation may be required in the event of a catastrophic system failure of a cylinder component, such as, for example, the pressure regulators and valving associated with the gas cylinders, or the failure of a downstream gas line or connection. The inability to isolate flow of the toxic gases as a result of such failures can cause dangerous concentration levels to be released to the atmosphere.

The ability to both adequately restrict flow to safe levels and isolate flow at a predefined set point condition is desirable. Other aspects of the present invention will become apparent to one of ordinary skill in the art upon review of the specification, drawings, and claims appended hereto.

### SUMMARY OF THE INVENTION

The present invention utilizes an auto shut off device to isolate gas flow. The auto shut off device includes a restrictive flow orifice (RFO) disc. As will be explained, the RFO disc is designed to flex in response to a predefined pressure drop that develops across the disc as a result of increased flow of gas through the predetermined openings or holes in the disc. The increased flow of gas may occur as a result of a downstream catastrophic failure or a loss of flow control. The pressure drop causes the RFO disc to flex from an open to a closed and sealed position, which blocks the discharge flow path, thereby preventing the gas from flowing downstream beyond the disc. In this way, the RFO disc confines the gas upstream of the disc.

In a first aspect of the invention, an auto shut off device for isolating the flow of pressurized gas from a gas discharge flow path is provided, comprising a restrictive flow orifice disc, the disc sealed in place to a first elastomeric member disposed at a first location; a second elastomeric member disposed at a second location, wherein the disc and the second elastomeric member form a flow path to the gas discharge flow path when the disc is in a relaxed state; one or more openings extending through a thickness of the disc and located between the first and the second elastomeric members, wherein the gas flows through the one or more openings to the flow path, the flow path configured to direct the gas to the gas discharge flow path when the disc is in the relaxed state; wherein the disc is configured to flex from the relaxed state towards the second elastomeric member and engage therewith to seal off the gas flow discharge path in response to a predetermined pressure drop across the disc resulting from an increased flow through the orifice

In a second aspect of the invention, an auto shut off device for isolating the flow of pressurized gas from a gas discharge flow path is provided, comprising a restrictive flow orifice disc, the disc held stationary between a first elastomeric member and a second elastomeric member, a periphery of the disc sealed to the first elastomeric member to prevent the flow of gas around the periphery; a second elastomeric member disposed along a top surface of the disc, the second elastomeric member disposed radially inward of the first elastomeric member, wherein the disc and the second elastomeric member form a flow path to the gas discharge flow path when the disc is in a relaxed state; one or more openings extending through a thickness of the disc and located between the first and the second elastomeric members, wherein the gas flows through the one or more openings to the flow path, the flow path configured to direct the gas radially inward beyond the second elastomeric member to the discharge flow path when the disc is in the relaxed state; wherein the disc is configured to flex from the relaxed state towards the second elastomeric member to seal off the gas flow discharge path in response to a predetermined pressure drop across the disc.

In a third aspect of the invention, a system for isolating the flow of gas within a pressurized cylinder is provided, comprising: a cylinder for holding a pressurized gas; a gas discharge pathway defined in part by a valve body affixed to an upper part of the cylinder, said valve body containing a sealing member configured to move from an closed position whereby flow path through the valve is blocked, to an open position whereby gas is allowed to flow through the valve body; a restrictive flow orifice disc disposed upstream of the valve body sealing member, said disc affixed between a first elastomeric member and a second elastomeric member, the first elastomeric member disposed along a periphery of the disc and the second elastomeric member is disposed radially inward of the second elastomeric member and along a top surface of the disc; a flow path defined by the second elastomeric member and the top surface of the disc, the flow path configured to direct gas to a gas discharge flow path when the disc is in a relaxed state; one or more openings extending along a thickness of the disc and located between the first and the second elastomeric members, the one or more openings forming an inlet to the flow path; wherein the disc is configured to flex from the relaxed state towards the second elastomeric member so as to seal the gas discharge pathway, the seal preventing the flow of gas through the discharge pathway.

### BRIEF DESCRIPTION OF THE DRAWINGS

The objects and advantages of the invention will be better understood from the following detailed description of the preferred embodiments thereof in connection with the accompanying figures wherein like numbers denote same features throughout and wherein:

FIG. 1 shows an auto shut off device incorporating the principles of the invention in which the device is in an open condition to allow gas to flow through openings of a flexible disc contained within a housing;

FIG. 2 shows the device of FIG. 1 in which the disc has flexed upwards into a closed position to block the flow of gas;

FIG. 3 shows an alternative embodiment of an auto shut off device in which a spring may be utilized to counteract the flexing of the disc;

FIG. 4 shows another embodiment of an auto shut off device in which an inner elastomeric member and an outer elastomeric member are disposed along the top portion of the disc;

FIG. 5 shows the disc of FIG. 4 in a flexed configuration;

FIG. 6 shows a graph of how the inventive disc responds under varying gas flow rate conditions;

FIG. 7 shows a graph of how a flow restrictor responds under varying gas flow rate conditions; and

FIG. 8 shows an alternative design in which a base piece and a stem piece are threaded to each other.

### DETAILED DESCRIPTION OF THE INVENTION

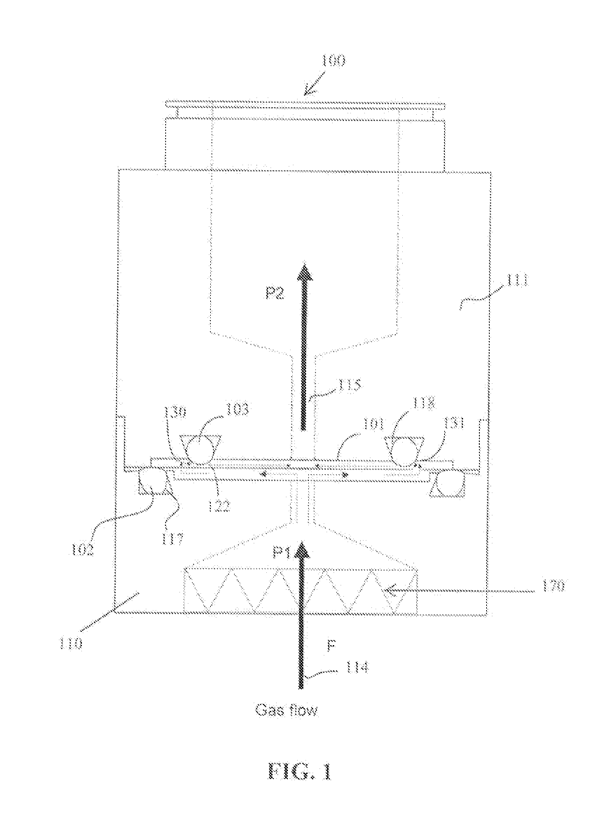

FIG. 1 shows one embodiment of an auto shut off device 100 in accordance with principles of the present invention. The device 100 may be positioned within a gas supply cylinder or downstream of the cylinder. Preferably, device 100 is positioned within the interior of a cylinder and upstream of a valve body (not shown). The device 100 includes a RFO disc 101, which operates as a flow restrictor under normal operating conditions. Generally speaking, and as will be explained in greater detail, the RFO disc 101 is designed to flex in response to a predetermined pressure drop created across the disc 101 as a result of a catastrophic failure downstream of the device 100. The RFO disc 101 flexes into a configuration which blocks the flow of gas downstream of the disc 101. The ability of the flexed disc 101 to confine the gas provides an enhanced level of safety.

FIG. 1 shows the configuration of the disc 101 in the relaxed state. The relaxed state occurs under normal operating conditions, which is defined by the absence of a catastrophic failure. Under normal operating conditions, the pressure drop (P1-P2) across the disc 101 is insubstantial. In one example, the pressure drop is 10 psig or less. Gas flows across the disc 101 through openings 130 and 131, and then along the gas discharge flow pathway 115. In such a relaxed state, the disc 101 provides a flow path for the gas to flow into discharge pathway 115. Typical normal operating flow rates across the relaxed disc may range from about 1 sccm to about 2500 sccm and, preferably, from about 10 sccm to about 200 sccm and more preferably from about 3 sccm to about 5 sccm. The pressure drop across the disc 101 at such normal operating flow rates remains below a threshold level at which the disc 101 is triggered to flex.

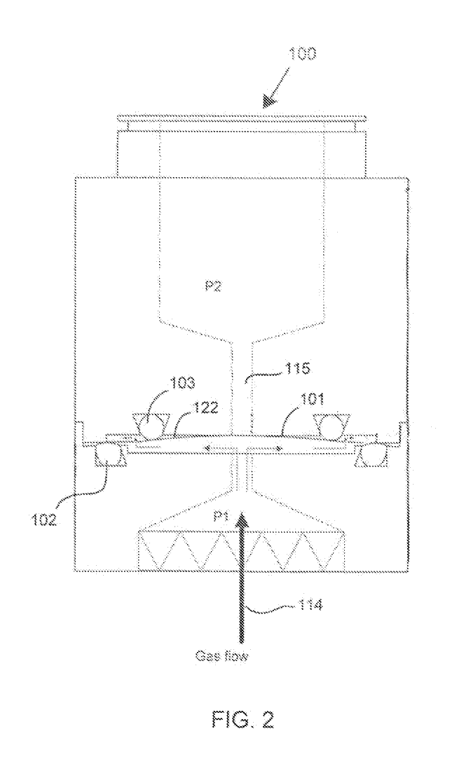

The disc 101 is disposed between the first and the second elastomeric members 102 and 103, respectively. The first elastomeric member 102 is sealed to the periphery of the disc 101 at the base piece 110, thereby preventing the flow of gas beyond the periphery of the disc 101. The second elastomeric member 103 is disposed inward of the first elastomeric member 102. The second elastomeric member 103 is not sealed to the disc 101. Thus, the disc 101 can flex in an upwards direction towards the member 103, as will be explained in FIG. 2. In the relaxed state of FIG. 1, the disc 101 is separated from the second elastomeric member 103 by a predefined gap to allow the flow of gas through flow path 122, as shown by the inwardly directed horizontal arrows along disc 101 in FIG. 1. Openings 130 and 131 extend along an entire thickness of the disc 101. The openings 130 and 131 are situated between the first and the second elastomeric members 102 and 103. The openings 130 and 131 provide passageways through which gas can flow across the disc 101, as indicated by the vertically directed arrows at the openings 130 and 131 in FIG. 1. After passing through openings 130 and 131, the gas can flow through flow path 122. Under normal operating conditions, flow path 122 directs gas inwards along disc 101 towards the inlet of the gas flow discharge pathway 115. Upon reaching the inlet of pathway 115, the gas flows upwards therethrough, as indicated by a vertically directed bold arrow in FIG. 1.

Still referring to FIG. 1, the RFO disc 101 is shown inserted into a base piece 110. Within the base piece 110, the disc 101 is sealed at its periphery to a first elastomeric member 102, which is disposed within a groove 117 of the base piece 110. The base piece 110 may contain a particulate filter 170, located at the bottom thereof at a gas inlet 114 to the auto shut off device 100. The gas inlet 114 is designated by a vertically directed bold arrow, shown in FIGS. 1 and 2.

An upper stem piece 111 mates onto the base piece 110 and onto the top portion of the disc 101. The upper stem piece 111 contains the second elastomeric member 103, which is disposed within a groove 118 of the stem piece 111. Both the base piece 110 and upper stem piece 110 contain passageways which are aligned with each other to create a gas inlet 114 and a gas discharge flow path 115 when the pieces 110 and 111 are mated.

FIG. 2 shows the auto shut off device 100 in which the disc 101 has flexed to block off the flow of gas into gas discharge pathway 115. The disc 101 flexes against the second elastomeric member 103 to block flow along the flow path 122 and the discharge pathway 115. The disc 101 can be designed to flex at any flow rate based upon several design parameters, including, but not limited to hole size, number of holes and disc thickness. In one embodiment, the disc 101 can be designed to trigger when the flow rates across the disc 101 range from about 200 sccm to about 10,000 sccm. In another embodiment, the disc 101 can be designed to flex when the gas flow rate is about 45 sccm or greater. Under normal operating conditions, the pressure (P1) upstream of the disc 101 and the pressure (P2) downstream of the disc 101 will be substantially similar because of the low flow rates gas across the disc 101. However, when flow through the openings 130 and 131 of the disc 101 increases as a result of a catastrophic failure downstream of the disc 101 (e.g., a cylinder component fails or a downstream mechanism fails) or loss of flow control, the downstream pressure of the disc (P2) decreases relatively fast. An increased pressure drop is developed across the disc 101 that causes the disc 101 to flex towards elastomeric member 103. As the disc 101 flexes or moves upwards in response to this pressure differential, it will contact and engage with the second elastomeric member 103 located on the upper stem piece 111. When the disc 101 has engaged with member 103, the disc 101 blocks the flow pathway 122 and the inlet 114 to gas discharge pathway 115. As a result, the gas flow stops along discharge pathway 115, as shown in FIG. 2. In the configuration of the disc 101 of FIG. 2, the pressure downstream of the disc 101 (P2) may drop to about atmospheric pressure while pressure upstream of the disc 101 (P1) substantially remains at about the cylinder pressure. This large pressure drop across the disc 101 maintains the disc 101 against the second elastomeric member 103. The disc 101 remains in the closed and flexed position. When the pressure drop is removed, the disc 101 can reconfigure into its normal relaxed orientation.

In the case of a catastrophic failure, without being bound by any particular theory, it is believed that a choked flow regime across the orifice disc 101 may develop to create the necessary force differential that causes disc 101 to flex and block gas flow. When a catastrophic failure occurs downstream of the disc 101 (e.g., a cylinder component fails or a mechanism downstream of the cylinder fails), a leak is formed downstream of the RFO device 100. The flow rate of gas higher than under normal operating conditions is created across the RFO disc 101 and eventually through the leak. Conservation of mass requires that the gas be replenished at a higher rate across the RFO disc 101. Thus, the flow rate of gas increases across the disc 101. However, the holes 130 and 131 within the RFO disc 101 limit replenishment of gas across the disc 101. A limiting flow rate condition known as a choked flow regime of the gas can eventually be developed across the disc 101, in which the flow rate no longer increases with a further decrease in the downstream pressure (P2) of the disc 101. The gas flow rate across the disc 101 attains a maximum value as dictated by the gas flow path holes 130 and 131 within the disc 101. As a result, P2 decreases relatively fast and, as a result of the choked flow regime, may not be compensated by the higher flow rate of gas. A predetermined pressure drop (P1-P2) across the disc 101 is reached causing the disc 101 to flex towards elastomeric member 103. As the disc 101 flexes or moves upwards in response to this pressure differential, it will contact and engage with the second elastomeric member 103 located on the upper stem piece 111. When the disc 101 has engaged with member 103, the disc 101 blocks the pathway 122 and the inlet 114 to gas discharge pathway 115. As a result, the gas flow stops along discharge pathway 115, as shown in FIG. 2. The disc 101 remains in the closed, flexed position until either the pressure at P1 is removed or the pressure downstream of the disc, P2, is pressurized. Either condition allows the disc 101 to relax and reconfigure into its normal, relaxed position, shown in FIG. 1.

The criteria for sizing a suitable auto shut off device in accordance with the embodiment shown in FIGS. 1 and 2 will be dependent upon various parameters. For example, the design of an auto shut off device to be disposed within the interior of a gas cylinder would preferably take into account the flow rate of gas exiting the cylinder under normal operating conditions, the flow rate threshold beyond which flow from the cylinder should be isolated and the maximum cylinder pressure being exerted at the inlet of the disc. In one example, a normal flow rate is in the range from about 3 sccm to about 5 sccm and the flow rate beyond which flow is to be isolated is in a range of from about 45 sccm to about 50 sccm. The maximum cylinder pressure (P1) to be exerted at the inlet of the disc is about 1250 psig. Given these operating conditions, a suitable design of the disc would allow the disc to remain substantially unflexed or relaxed at a flow rate of about 3 sccm to about 5 sccm across the disc and to transform from a relaxed to a flexed configuration to shut off gas flow when the flow rate reaches about 45 sccm to about 50 sccm. Gas flow through the one or more openings of the disc can be estimated utilizing the orifice plate calculation, as recognized in the art. Based on the orifice plate calculation, a single opening of 10 microns produces a pressure drop of about 200 psig when the flow rate across the disc reaches about 45 sccm or greater. Accordingly, in this example, a disc is preferably selected which can flex at a pressure drop of about 200 psig and corresponding flow of 45 sccm or greater.

A variety of parameters can determine the flexing behavior of the disc. One parameter may include, for example, the selection of a suitable material of construction and whether such material should be heat treated. The design contemplates various materials such as, for example, nickel, chromium, stainless steel and alloys thereof. Each of the materials will require different thicknesses to flex at a predetermined gas flow rate for a particular gas having a defined pressure, P1. Examples of other parameters can include the thickness of the disc, the strength of the disc, the number and size of holes within the disc, the net effective flow area of the holes across the disc and the total active area where the pressure is applied along the surface of the disc. In one example, the hole size may range from about 1 micron to about 1000 microns, and preferably from about 10 microns to about 1000 microns. Still further, other disc parameters may include the distance the disc is required to flex between the first and second elastomeric members. The greater the distance between the first and the second elastomeric members, the more the disc will be required to flex in order to contact elastomer 103 and thereby isolate flow.

Still further, the design of a suitable disc should also take into consideration the type of gas being supplied. The type of gas to be supplied can affect the required thickness of the disc. A low inlet pressure to the disc (P1) may allow a relatively thinner disc to be employed. For example, gases such as arsine are liquefied gases, having a pressure limited by their vapor pressure. Arsine exerts a vapor pressure of approximately 200 psig at 70° F. Because such a relatively low supply pressure exerts a small amount of force (P1) at the bottom of the RFO disc, a thin disc can be used. However, gases, such as BF₃ or SiH₄, are filled into cylinders at pressure of 1250 psig or higher, these applications may require a thicker disc.

An optimal design of the auto shut off device will involve balancing these parameters to allow the disc to flex in response to a predetermined flow rate created across the disc during a catastrophic failure. These parameters interact with each other to determine the final design and construction of the auto shut off device. In one example, a disc with a single opening of 10 microns that is formed from un-heat treated 316 stainless steel and having a thickness of 250 microns with a diameter of 0.75 inches may be selected to be disposed between a first elastomeric member 102 and a second elastomeric member 103, as shown in FIG. 1. The first elastomeric member 102 has an inner diameter of about 0.614 inches and thickness of 0.070 inches. The second elastomeric member 103 has an inner diameter of about 0.364 inches and a thickness of about 0.070 inches. With such a design, the 316 stainless steel disc preferably remains relaxed at flow rates of about 3-5 sccm, but flexes into the closed configuration of FIG. 2 when the flow rate of the particular gas being across the single opening of the disc of about 45 sccm or greater.

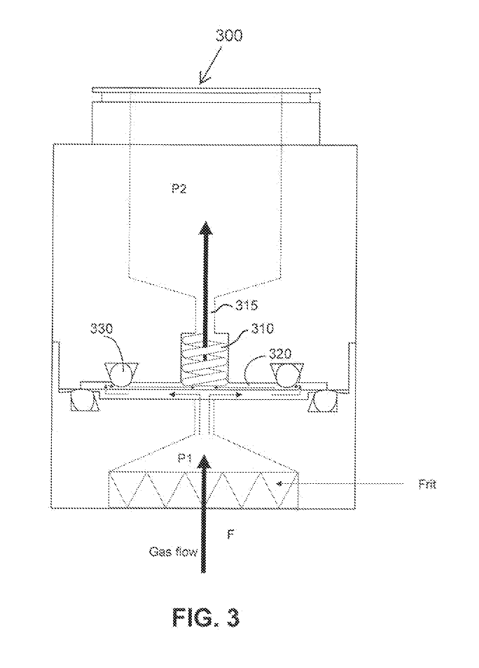

Other designs may also be utilized to achieve a predetermined flexing of the disc. FIG. 3 shows an alternative embodiment of an auto shut off device 300 in which a spring 310 may be utilized to counteract the flexing of the disc 320, should the disc 320 prematurely flex upwards under normal flow rate operating conditions. The spring 310 possesses a predetermined tension in the windings, which exerts a downward resistance, as the disc 320 flexes in an upward direction towards the second elastomeric member 330. Accordingly, an auto shut off device 300, which incorporates a spring 310, allows the use of a thin disc 320 that does not prematurely flex as a result of a relatively insubstantial force generated during normal gas flow rates. However, if the pressure differential across the disc 320 is sufficiently large and reaches a predetermined threshold, then the combination of the disc 320 with the spring 310 is preferably designed such that the disc 320 will counteract the downward resistance of the spring 320 and be able to flex upwards against the second elastomeric member 330 to block the flow of the gas into the discharge pathway 315. Accordingly, the spring 310 may fine tune the responsiveness of when the disc 320 is triggered to flex.

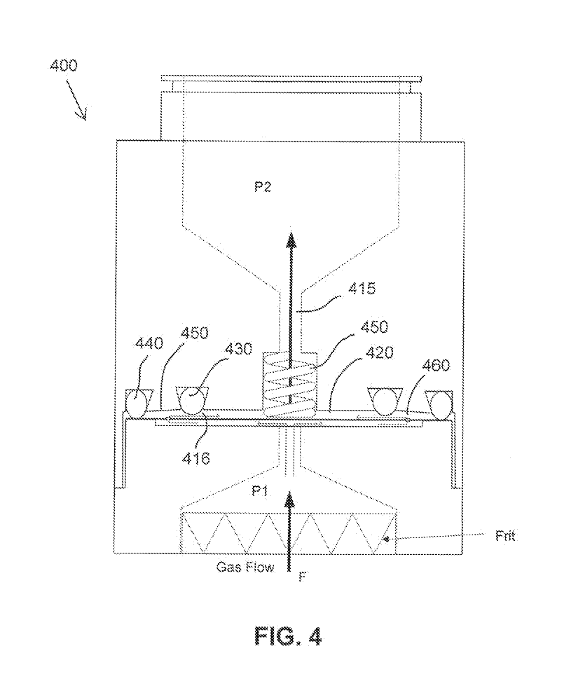

In addition to flexing, the inventive auto shut off device can also block gas flow by axial translation. In this regard, FIG. 4 shows another embodiment of an auto shut off device 400 in which inner elastomeric member 430 and outer elastomeric member 440 are disposed along the top of the disc 420. The disc 420 is shown secured in position to the outer elastomeric member 440. A predetermined gap exists between disc 420 and the inner elastomeric member 430 to form a passageway 416. FIG. 4 shows the disc 420 in an open configuration for normal gas flow rates to pass across disc 420. During normal operating flow rate conditions the disc 420 remains open as shown in FIG. 4 to allow the flow of gas through openings 450 and 460 of the disc 420, and thereafter along passageway 416 towards discharge pathway 415. As with the design shown in FIG. 3, spring 450 exerts a downward force against disc 420 to prevent the disc 420 from prematurely moving into a flexed configuration.

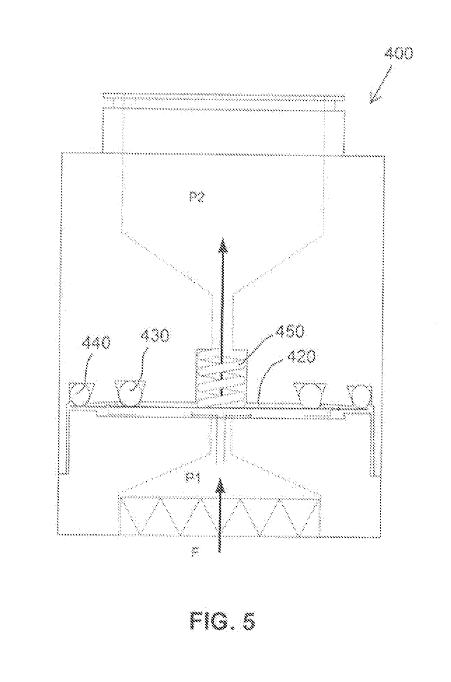

FIG. 5 shows the disc 420 of FIG. 4 in a closed condition. Specifically, when a predetermined excess flow condition occurs (e.g., at 50 sccm or greater), the pressure drop across the disc 420 increases to a threshold value that creates a sufficient upward force against the bottom portion of the disc 420. The force causes the disc 420 to oppose the downward force exerted by the spring 450 and thereby axially translate upwards towards the inner elastomeric member 430 during flexing. The disc 420 freely moves in an upward direction as a result of both elastomeric members 430 and 440 disposed along the top portion of the disc 420. Eventually, this axial translation with flexing causes the disc 420 to contact and engage with the inner elastomeric member 430. The engagement of the disc 420 with the inner elastomeric member 430 blocks off passageway 416, thereby preventing the gas flow into the discharge pathway 415. In addition to the design parameters described with the device 100 of FIG. 1, the device 400 shown in FIG. 4 and FIG. 5 may also take into account the hardness of the outer elastomeric member 440 and the stiffness of the spring 450 to adequately fine tune the flexing responsiveness of the device 400.

### Example

A test was conducted to evaluate the ability of the inventive auto shut off device to isolate flow in response to a predetermined flow rate excursion. The auto shut off device utilized for the test was that shown in FIG. 1. The disc was circular and flat shaped with a thickness of 0.010 inches. The disc was formed from non-heat treated Inconel® alloy and had a single opening through its thickness that was 10 microns in size. The disc was housed within the base and stem shown in FIG. 1 and thereafter connected to a flow line.

The flow line upstream of the auto-shutoff device was connected to a nitrogen line maintained at a pressure of 1250 psig. The downstream side of the auto-shutoff device was connected to a manifold. The manifold included two mass flow controllers. One of the flow controllers had a flow rate range of 0-10 sccm (10 sccm MFC). The second flow controller had a flow rate range of 0-1000 sccm (1000 sccm MFC). A valve was placed upstream of each of the mass flow controllers.

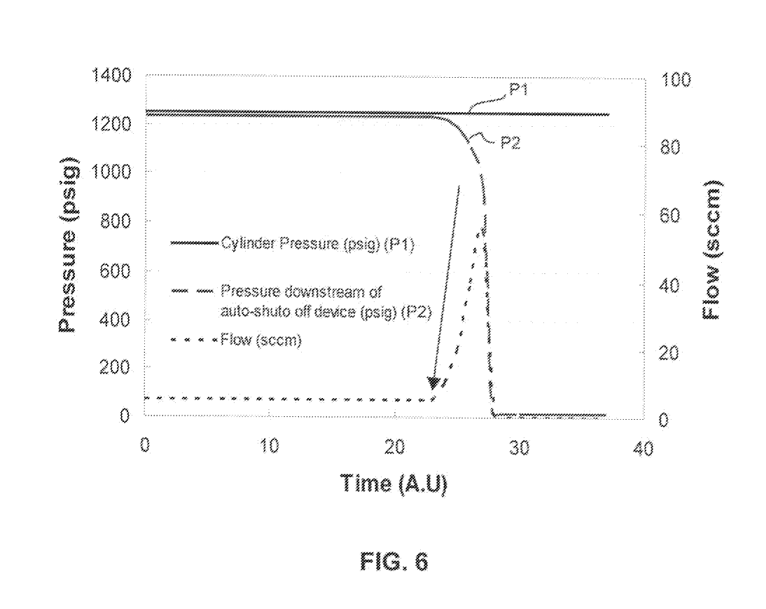

The pressure upstream and downstream of the RFO disc was measured using two separate pressure transducers (PTs). Both MFCs and the PTs were connected to a data acquisition system. At the start of the test, the 10 sccm MFC was set to a target flow rate of 5 sccm. The valve upstream of the 10 sccm MFC was opened. As shown in FIG. 6 by the short dashed line, a flow rate of 5 sccm was measured to flow across the disc, indicating that that disc was not prematurely configured in a flexed state. The pressure upstream of the disc, P1, was measured to remain at 1250 psig, as shown by the solid horizontal line in FIG. 6. The pressure downstream of the disc, P2, was estimated to be about 1245 psig. FIG. 6 shows that P2 under normal operating conditions was slightly less than P1. The insubstantial pressure drop, P1-P2, of 5 psig did not cause the disc to flex, as is the required configuration when operating at the low flow rates of 3-5 sccm.

To simulate a downstream failure characterized by a condition of high flow, the valve upstream of the 1000 sccm MFC was opened with the flow through the 1000 sccm MFC set to about 200 sccm. The region at which the valve failure was simulated to occur is designated by the vertical arrow, shown in FIG. 6. The flow rate measured through the disc approached about 55-58 sccm as shown in FIG. 6. As the flow rate across the disc increased beyond about 50 sccm the estimated pressure downstream of the disc, P2, decreased to about 1050 psi. The pressure upstream of the disc, P1 remained unchanged at 1250 psig. Accordingly, it was observed that as the flow rate increased to about 55-58 sccm, a pressure drop of about 200 psig formed across the disc. Such a pressure drop was sufficient to exert an upward force along the bottom of the disc and cause the disc to flex (FIG. 2) upwards towards the inner elastomeric member. The engagement of the disc with the inner elastomeric member blocked off flow of the nitrogen gas. After the disc isolated the flow of nitrogen gas, the downstream pressure, P2, was calculated to rapidly fall to zero, as FIG. 6 illustrates. The flow rate through the MFC correspondingly dropped to zero as indicted in FIG. 6, thereby indicating that the disc flexed and closed the gas flow path. The disc remained in the closed, flexed position. Accordingly, the disc demonstrated the ability to allow gas flow of about 5 sccm at normal operating conditions while isolating gas flow at about 50-60 sccm. The response time observed for the auto shut off was less than a second, thereby minimizing the amount of gas that leaked out from the cylinder.

### Comparative Example

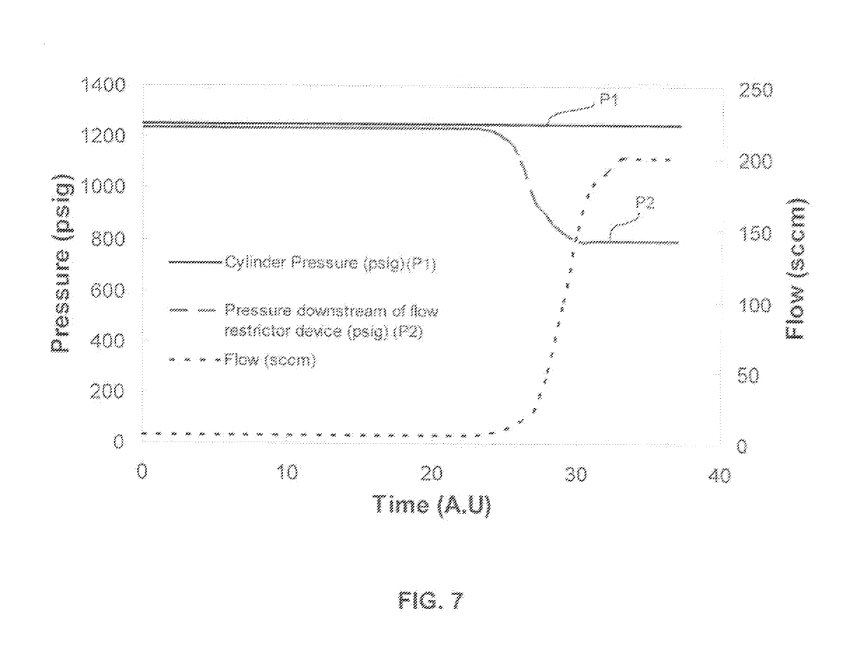

A comparative test run utilizing a flow restrictor device was performed in a manner similar to that described above. A conventional RFO was utilized. FIG. 7 shows a graph of the results of the test. The 1000 sccm MFC was set to 100% of its maximum capability. When the downstream failure was simulated, characterized by a condition of high flow, the restrictor did not shut off the flow. Instead, the restrictor stabilized the flow to 200 sccm as measured by the MFC. Flow was not isolated and the pressure downstream of the flow restrictor, P2, did not reduce to zero. Accordingly, significant amounts of gas leaked from the cylinder.

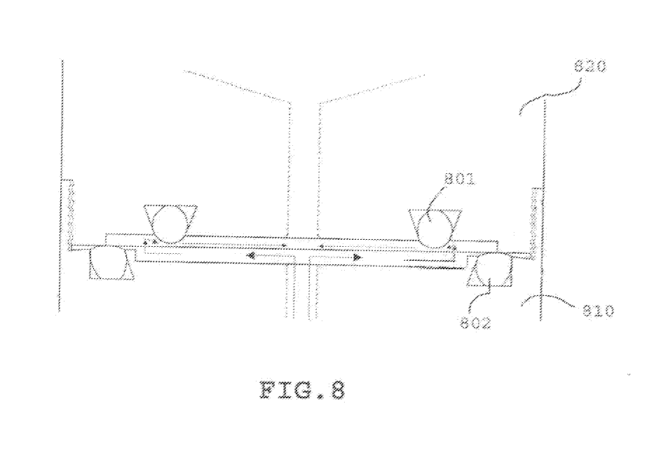

Various other design modifications for the auto shut off device are contemplated. For example, FIG. 8 shows an alternative design in which the base 810 and stem 820 can be threaded to each other. Although the elastomeric members 801 and 802 are shown as elastomeric o-ring members, other means of sealing the disc to the base 810 and stem 820 are contemplated. For example, soft metals, such as lead, nickel, copper, may be utilized to seal the base 810 with the stem 820. Alternatively, polymer encapsulated metallic seals can be used such as Teflon® coated stainless steel seats. Still further, the cross section of the seal can be modified as needed to achieve the proper seal. For example, rectangular and oval cross-sectional shape designs may be employed.

In another design variation, the RFO device 100 can be welded in place to the housing that it is contained within, as opposed to disposing the periphery of the disc 101 adjacent to a first elastomeric member 102 that is sealed to the base piece 110, as shown in FIG. 1.

The auto shut off device as described in the various embodiments may be disposed anywhere within a gas delivery system where an increase in flow rate may occur, potentially as a result of a catastrophic downstream failure. For example, the device can be positioned upstream of a cylinder valve seat, located either in the cylinder valve body or cylinder neck. Preferably, the device is positioned within the interior of a cylinder body and upstream of an auto-controlled flow device, such as a vacuum actuated check valve, regulator, mass flow controller or other flow control device.

The auto shut off device may also be employed in combination with various valve and regulator devices, including, for example, the vacuum actuated valve and regulator devices disclosed in U.S. Pat. Nos. 5,937,895; 6,007,609; 6,045,115; 6,959,724; 7,905,247, and U.S. application Ser. No. 11/477,906, each of which is incorporated herein by reference in their entirety. In one embodiment, the auto shut off device may be disposed upstream of the vacuum actuated device or regulator disposed within the interior of a gas cylinder. In another embodiment, the auto shut off device may be used as an alternative for the glass capillaries disclosed in U.S. application Ser. No. 11/477,906.

While it has been shown and described what is considered to be certain embodiments of the invention, it will, of course, be understood that various modifications and changes in form or detail can readily be made without departing from the spirit and scope of the invention. It is, therefore, intended that this invention not be limited to the exact form and detail herein shown and described, nor to anything less than the whole of the invention herein disclosed and hereinafter claimed.

1. An auto shut off device for isolating the flow of pressurized gas from a gas discharge flow path, comprising
a restrictive flow orifice disc, the disc sealed in place by a first elastomeric member disposed at a first location;
a second elastomeric member disposed at a second location, wherein the disc and the second elastomeric member form a flow path to the gas discharge flow path when the disc is in a relaxed state;
one or more openings extending through a thickness of the disc, the one or more openings located between the first and the second elastomeric members, wherein the gas flows through the one or more openings to the flow path, the flow path configured to direct the gas to the gas discharge flow path when the disc is in the relaxed state;
wherein the disc is configured to flex from the relaxed state towards the second elastomeric member and engage therewith to seal off the gas flow discharge path in response to a predetermined flow rate which causes a pressure drop across the disc.

2. The device of claim 1, wherein the disc is configured to move from the relaxed state to the flexed state under a choked flow regime.

3. The device of claim 1, wherein the first location is along a periphery of the disc and the second location is along a top surface of the disc that is radially inward from the second location.

4. The device of claim 1, wherein the disc comprises a thickness ranging from about 0.005 inches to about 0.050 inches.

5. The device of claim 1, wherein each of the first location and the second location is along a top surface of the disc so as to allow the disc to flex and axially translate towards the second elastomeric member.

6. An auto shut off device for isolating the flow of pressurized gas from a gas discharge flow path, comprising
a restrictive flow orifice disc, the disc held stationary between a first elastomeric member and a second elastomeric member, a periphery of the disc sealed to the first elastomeric member to prevent the flow of gas around the periphery;
a second elastomeric member disposed along a top surface of the disc, the second elastomeric member disposed radially inward of the first elastomeric member, wherein the disc and the second elastomeric member form a flow path to the gas discharge flow path when the disc is in a relaxed state;
one or more openings extending through a thickness of the disc, the one or more openings located between the first and the second elastomeric members, wherein the gas flows through the one or more openings to the flow path, the flow path configured to direct the gas radially inward beyond the second elastomeric member to the discharge flow path when the disc is in the relaxed state;
wherein the disc is configured to flex from the relaxed state towards the second elastomeric member to seal off the gas flow discharge path in response to a predetermined flow rate which results in a pressure drop across the disc.

7. The device of claim 6, wherein the disc is formed from a material selected from the group consisting of nickel, stainless steel, chromium and alloys thereof.

8. The device of claim 6, wherein the disc comprises a plurality of openings equally spaced apart from each other, the plurality of openings located at about the periphery of the disc.

9. The device of claim 6, wherein the first elastomeric member is seated into a bottom piece and the second elastomeric member is seated into a top piece, the bottom and top pieces being mated together.

10. The device of claim 6, wherein the disc is configured to flex when the flow rate exceeds a flow rate of about 40 sccm or greater.

11. The device of claim 6, wherein the disc remains relaxed when the flow rate is 10 sccm or less.

12. A system for isolating the flow of gas within a high pressure cylinder, comprising:
a cylinder for holding a pressurized gas;
a gas discharge pathway defined in part by a valve body affixed to an upper part of the cylinder;
a restrictive flow orifice disc disposed upstream of the valve body, said valve body containing a sealing member configured to move from an closed position whereby flow path through the valve is blocked, to an open position whereby gas is allowed to flow through the valve body, the disc affixed between a first elastomeric member and a second elastomeric member, the first elastomeric member disposed along a periphery of the disc and the second elastomeric member is disposed radially inward of the first elastomeric member and along a top surface of the disc;
a flow path defined by the second elastomeric member and the top surface of the disc, the flow path configured to direct gas to a gas discharge flow path when the disc is in a relaxed state;
one or more openings extending along a thickness of the disc and located between the first and the second elastomeric members, the one or more openings forming an inlet to the flow path;
wherein the disc is configured to flex from the relaxed state towards the second elastomeric member so as to seal the gas discharge pathway in response to a predetermined pressure drop across the disc, the seal preventing the flow of gas through the discharge pathway.

13. The system of claim 12, wherein the gas flow across the disc and the flow path occurs at a flow rate less than about 10 sccm.

14. The system of claim 12, the valve body comprising a vacuum actuated valve.

15. The system of claim 12, further comprising a spring disposed above the top surface of the disc.

16. The system of claim 12, wherein the second elastomeric member is disposed along the top surface of the disc.

17. The system of claim 12, wherein the disc comprises a thickness between about 0.005 inches to about 0.050 inches.

18. The system of claim 12, wherein the first elastomeric member is seated into a bottom piece and the second elastomeric member is seated into a top piece, the bottom and top pieces being mated together.

19. The system of claim 12, wherein the openings range from about 1 micron to about 1000 microns in size.

20. The system of claim 12, wherein the disc is configured to flex when the predetermined pressure drop reaches about 200 psig.
